(19) United States
(12) Patent Application Publication
(10) Pub. No.: US 2016/0360165 A1
(43) Pub. Date: Dec. 8, 2016

(54) SYSTEMS AND METHODS FOR CARE MONITORING

(71) Applicant: THE GENERAL HOSPITAL CORPORATION, Boston, MA (US)

(72) Inventors: Bob Hurley, Milton, MA (US); John Pellecer, Boston, MA (US); Gianluca De Novi, Cambridge, MA (US); Mark Ottensmeyer, Watertown, MA (US)

(21) Appl. No.: 15/116,494

(22) PCT Filed: Feb. 4, 2015
(86) PCT No.: PCT/US15/14476

§ 371 Date: Aug. 3, 2016

Related U.S. Application Data
(60) Provisional application No. 61/936,657, filed on Feb. 6, 2014.

(51) Int. Cl. H04N 7/18; G06T 7/00; G06F 19/00; H04N 5/225

(52) U.S. Cl. CPC H04N 7/188; H04N 5/2252; G06T 7/0018; G06F 19/3418

(57) ABSTRACT

A systems and methods for monitoring a patient in or around a bed is provided. Systems and methods are provided for a medical monitoring system that is capable of identifying a positional state, or a sequence of positional states, of a patient in or around a bed, and determining if the positional state, or sequence of positional states, is dangerous to the patient. Upon determining the patient is in danger, an alert is communicated to one or more caregivers.

### CROSS-REFERENCES TO RELATED APPLICATIONS

The present application is based on, claims priority to, and incorporates herein by reference in its entirety, U.S. Provisional Patent Application No. 61/936,657, filed Feb. 6, 2014, and entitled “Care Monitor.”

### STATEMENT REGARDING FEDERALLY SPONSORED RESEARCH

Not Applicable.

### BACKGROUND

This disclosure relates generally to monitoring a patient in a bed and, more specifically, to medical monitoring systems and methods used to assist a caregiver by remotely monitoring a patient in a bed and alerting the caregiver based on a position, or a sequence of positions, of the patient.

Many patient populations benefit from monitoring, including as non-limiting examples, the elderly, the disabled, those recovering from surgery or trauma, and many others. For discussion purposes, the following illustrations will be made with respect to the elderly, but this is but one example of a relevant population.

Mobility is fundamental to successful aging in adults and reflects health status and quality of life. Elderly adults can be susceptible to decreased mobility, which can be associated with adverse outcomes, including functional decline, increase risk of falls, and a need for nursing home placement, even after controlling for illness, severity, and comorbidity. During hospitalization and subsequent rehabilitation, new aspects of mobility, such as ability to move in bed and ability to transfer in and out of bed, become determinants of overall health and important prognostic factors. Thus, monitoring a patient's mobility while in bed can be instrumental when assessing the patient's health and progress.

Furthermore, reduced mobility in elderly adults can also lead to an increased risk of falling while walking or falling out of bed. Falling out of bed is a common cause of bed-related injuries, such as skin lacerations that require suturing, bone fractures, joint dislocations, intracranial hemorrhage, and death. Other patient injuries can happen in beds when agitated and hostile patients cause themselves harm by extubation or improper removal of medical devices, such as intravenous lines, indwelling urinary catheters, and feeding tubes. Monitoring an elderly patient in bed can aid the prevention of the patient falling from bed and potentially reduce the occurrence of bed related injuries.

### BRIEF SUMMARY

The present disclosure provides systems and methods for monitoring a patient in or around a bed and other situations or locations. In particular, systems and methods are provided for a medical monitoring system that is capable of identifying a positional state, or a sequence of positional states, of a patient, for example, in or around a bed, and determining if the positional state, or sequence of positional states, is dangerous to the patient. Upon determining the patient is in danger, an alert is communicated to one or more caregivers.

In one aspect, the present disclosure provides a medical monitoring device including a housing mounted substantially proximate to a bed, a camera rotatably mounted within the housing and arranged to acquire images of a patient in or around a bed, and a local processor configured to process the images acquired by the camera and determine a positional state of the patient.

In another aspect, the present disclosure provides a medical monitoring device including a housing mounted substantially above a bed, a camera rotatably mounted within the housing and arranged to acquire images of a patient on or around the bed, and a local processor configured to process the images acquired by the camera and determine a positional state, or a sequence of positional states, of the patient. The local processor is further configured to generate event data including the positional state, or the sequence of positional states, and a time. The medical monitoring system further includes a remote processor located remotely from the local processor and in communication with the local processor. The remote processor configured to receive the event data from the local processor and determine if the patient is in danger and communicate to one or more caregivers an alert message.

In yet another aspect, the present disclosure provides a method for remotely monitoring a patient in or around a bed. The method includes imaging the patient in or around the bed with a camera mounted above the bed. The camera being rotatably mounted within a housing. The method further includes determining a positional state of the patient in the bed, communicating the positional state of the patient and a time to a remote processor, generating an alert message if the remote processor determines that the patient is in danger, and notifying one or more caregivers of the alert message.

The foregoing and other aspects and advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims and herein for interpreting the scope of the invention.

### BRIEF DESCRIPTION OF DRAWINGS

The invention will be better understood and features, aspects and advantages other than those set forth above will become apparent when consideration is given to the following detailed description thereof. Such detailed description makes reference to the following drawings.

FIG. 1 shows an orthographic view of a medical monitoring system in accordance with one embodiment of the present disclosure.

FIG. 2 shows the underside and mounting surface features of a housing of the medical monitoring system of FIG. 1.

FIG. 3 shows an orthographic view of a medical monitoring system in accordance with one embodiment of the present disclosure.

FIG. 4 shows details of the bottom surface of the medical monitoring system of FIG. 3.

FIG. 5 shows a top cross-sectional view of the medical monitoring system of FIG. 3.

FIG. 6 shows a right cross-sectional view of the medical monitoring system of FIG. 3.

FIG. 7 shows an orthographic cross-sectional view of the medical monitoring system of FIG. 3.

FIG. 8 shows a front cross-sectional view of the medical monitoring system of FIG. 3.

FIG. 9A illustrates a first rotation of a camera of the medical monitoring system of FIG. 3 in a first direction

FIG. 9B illustrates a second rotation of a camera of the medical monitoring system of FIG. 3 in a first direction.

FIG. 10A illustrates a first rotation of a camera of the medical monitoring system of FIG. 3 in a second direction.

10B illustrates a first rotation of a camera of the medical monitoring system of FIG. 3 in a second direction.

FIG. 11 is a schematic illustration of a medical monitoring system in accordance with one embodiment of the present disclosure

FIG. 12 is a flow chart setting forth the steps for operating the medical monitoring system of FIG. 11.

FIG. 13 is a flow chart setting forth the steps for determining a positional state of a patient in accordance with the present disclosure.

FIG. 14 is a flow chart setting for the steps for analyzing a pattern in a sequence of positional states in accordance with the present disclosure.

FIG. 15 is a flow chart illustrating the use of a state machine to recognize a pattern in a sequence of positional states in accordance with the present disclosure.

FIG. 16 is a flow chart illustrating the use of a neural network to recognize a pattern in a sequence of positional states in accordance with the present disclosure.

### DETAILED DESCRIPTION

Currently, monitoring and analysis of an elderly patient's mobility can be carried out by a caregiver at a hospital, assisted living facility, home, or other locations. However, patients can spend a substantial portion of a day in bed making this monitoring time and resource intensive, and the analysis qualitative at best. As one non-limiting example of a patient population, the following discussion will include elderly, but could include any other population. Additionally, the symptoms and signs of disease onset in elderly adults are frequently non-specific and may manifest with subtle behavioral changes either with patterns of decreased activity or psychomotor agitation. Thus, the limited frequency in clinical monitoring and lack of quantitative data present a major problem when detecting subtle behavioral changes and analyzing the patient's mobility. Due to the current difficulties in patient monitoring and acquiring quantitative mobility data, it would be desirable to have a more robust, flexible, adaptable, and intelligent medical monitoring system. It would be desirable that such a system can operate continously.

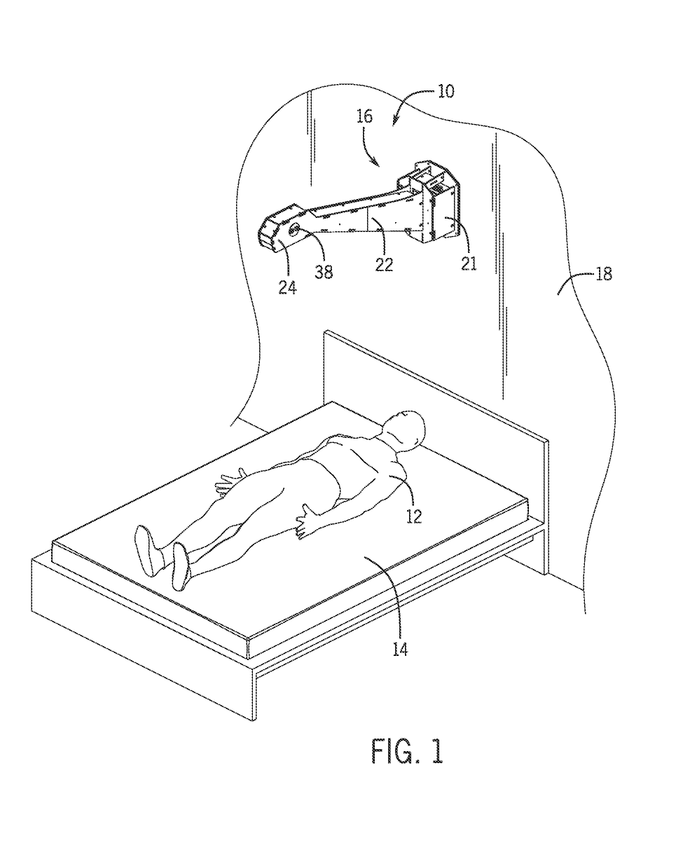

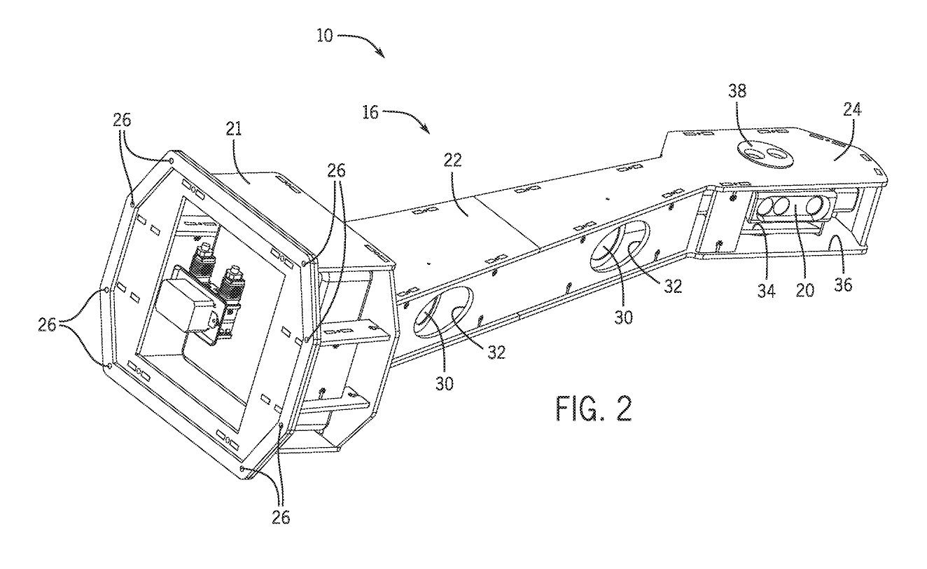

FIG. 1 shows an orthographic view of one non-limiting example of a medical monitoring system 10 monitoring a patient 12 in a bed 14. While a bed 14 is illustrated, this particular configuration is non-limiting. That is, the system 10 may be used within a variety of environments, including, but not limited to, chairs, cribs, couches, physical-therapy devices, and the like. With reference to FIG. 1 and FIG. 2, the medical monitoring system 10 includes a housing 16 mounted on a wall 18 generally proximate to or, in this case, above the bed 14, and a camera 20 rotatably mounted within the housing 16 and arranged to image the patient 12 in or around the bed 14. The system 10 may be arranged in other configurations. For example, if monitoring a chair or couch, it may be preferable that the camera 20 be located across from the chair and, thus, may be mounted on a wall, or integrated within furniture or appliances. Also, the device may be a mobile device that is self-standing. In the illustrated, non-limiting example, the housing 16 can be fabricated from a hard plastic material or, in other non-limiting configurations, the housing can be fabricated from a metal, a composite, or any viable material known in the art.

The housing 16 includes a base 21 arranged to engage the wall 18 and an extending arm 22 extending from the base 21 to a head 24. The base 21 includes a plurality of apertures 26 each arranged to receive a fastening element (not shown) for mounting the housing 16 to the wall 18. An electrical receptor 28 is arranged within the base 21 of the housing 16 that can be configured to receive power connections and/or network communication connections for the medical monitoring system 10. The extending arm 22 includes a pair of lighting features 30, each swivel mounted within a light aperture 32 at opposing ends of the extending arm 22. Although a pair of lighting features 30 are described in this non-limiting example, it should be known that other non-limiting arrangements may including more or fewer lighting features 30 as desired. The lighting features 30 are arranged to face the bed 14 and can be repositioned, as desired. For example, the repositioning may be done manually. Alternatively, the housing 16 may include one or more electromechanical features configured to control the positioning of the lighting features 30.

The camera 20 is mounted to a frame 34 within the head 24 of the housing 16 and arranged to view the bed 14 and the patient 12 through an opening 36 defined by the head 24. Though not illustrated, the opening 36 may be restricted by a plate or other device with a smaller opening or slot that obstructs the view of the camera 20 and associated mechanisms and protects the camera 20 and associated mechanisms. The frame 34 is attached to a pair of rotation elements 38 arranged on opposing sides of the head 24. The rotation elements 38 are rotatably coupled to the head 24 of the housing 16, which enables rotation of the camera 20 in a plane substantially parallel with a longitudinal direction of the bed 14. In other non-limiting configurations, the housing 16 may include an electromechanical feature configured to control the rotation of the camera 16.

Rotation of the camera 20 allows adjustments to be made to a viewing area of the camera 20. For example, if the bed 14 was moved substantially further away from the wall 18 to make room for medical equipment, then the rotation elements 38 can be rotated to enable to the camera 20 to view the bed 14 without repositioning or modification to the housing 16. Additionally or alternatively, a lens could be placed between the camera 20 and the bed 14 to enlarge the view area of the camera 20.

In the illustrated, non-limiting example, the camera 20 is a 3-D camera capable of acquiring 3-D depth information using visible or non-visible light, as well as video and audio information. The camera 20 may use infrared sensing technology to acquire the necessary 3-D depth information or any technology capable of acquiring the necessary 3-D depth information known in the art or developed in the future. The camera 20 may be a Microsoft Kinect®, a mobile device, or other device known in the art or developed in the future capable of acquiring the necessary 3-D depth, video, and audio data.

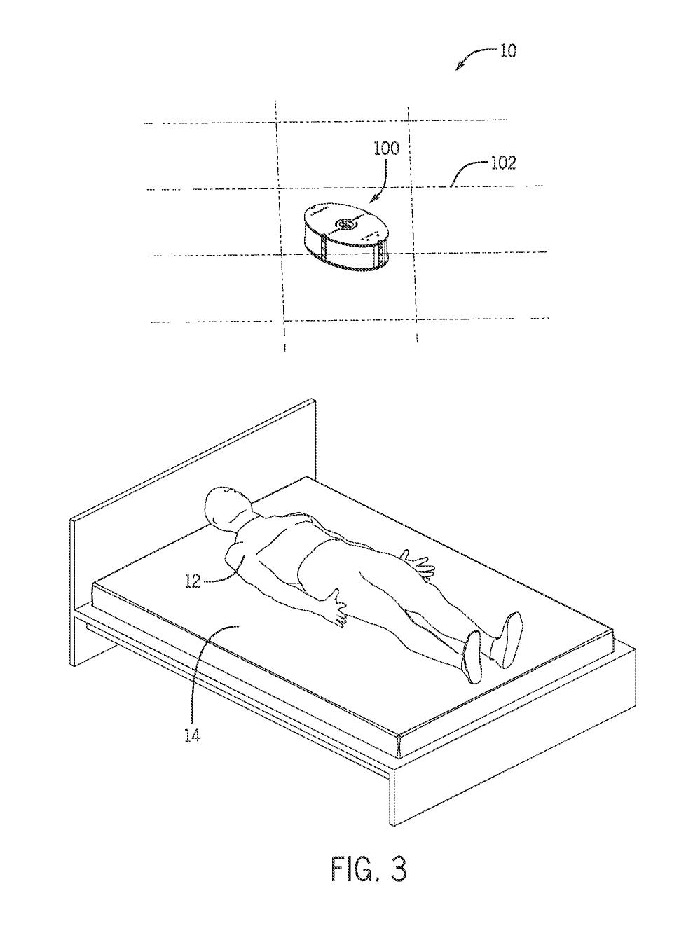

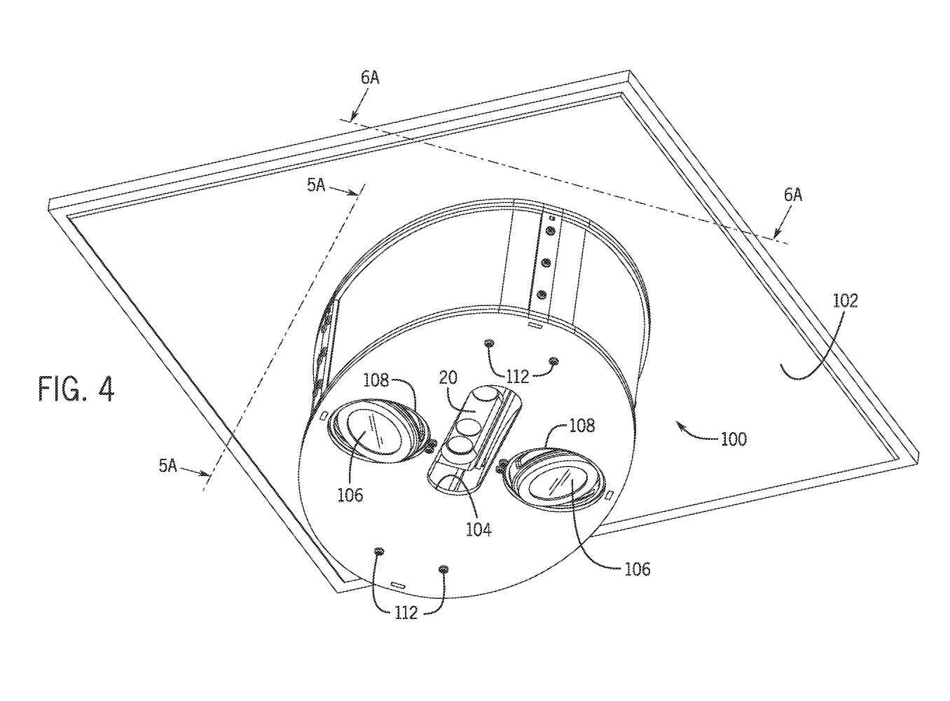

FIG. 3 shows an orthographic view of another non-limiting example of the medical monitoring system 10 monitoring the patient 12 in or around the bed 14. With reference to FIG. 3 and FIG. 4, the medical monitoring system 10 includes a housing 100 mounted on a ceiling 102 generally above the bed 14, and a camera 20 rotatably mounted within the housing 100 and arranged to image the patient 12 in or around the bed 14. In some configurations, the system 10 may be designed to be integrated into the ceiling and, thus, be flush with the ceiling when viewed from the room. The housing 100 may be secured to a main structure of a building above the ceiling 102 using an eyebolt (not shown) and a cable (not shown) as an additional safety measure preventing the housing 100 from falling on the patient 14. In the illustrated, non-limiting example, the housing 100 can be fabricated from a hard plastic material or, in other non-limiting configurations, the housing 100 can be fabricated from a metal, a composite, or any viable material known in the art.

The housing 100 defines an alternative shape and includes an imaging port 104 and a pair of lighting features 106 arranged on opposing sides of the imaging port 104 and facing the bed 14. The lighting features 106 are each swivel mounted within a light aperture 108 enabling manual repositioning of the lighting features 108. In another non-limiting configuration, the housing 100 may include one or more electromechanical features configured to control the positioning of the lighting features 106.

The imaging port 104 is dimensioned to enable the camera 20 to view the bed 14 and the patient 12 through the imaging port 104. In other non-limiting configurations, the imaging port 104 may define a different shape, for example, the imaging port 104 may define a substantially circular, elliptical or rectangular shape. In one non-limiting configuration, the camera 20 may utilize infrared sensing to acquire 3-D depth information and an infrared filter may be received within the imaging port 104 preventing the patient 12 from viewing the camera 20 within the housing 100.

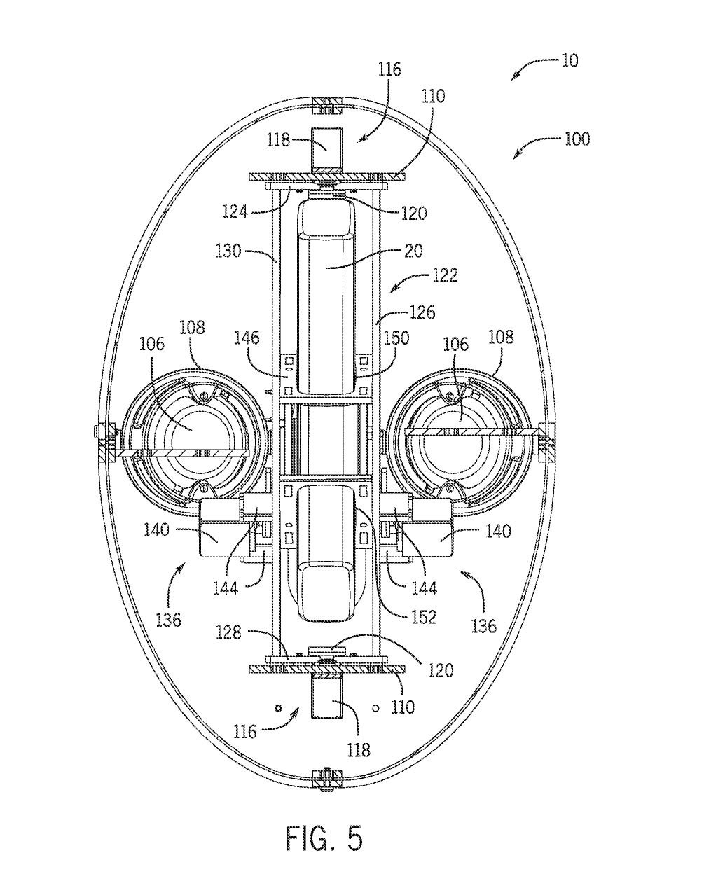

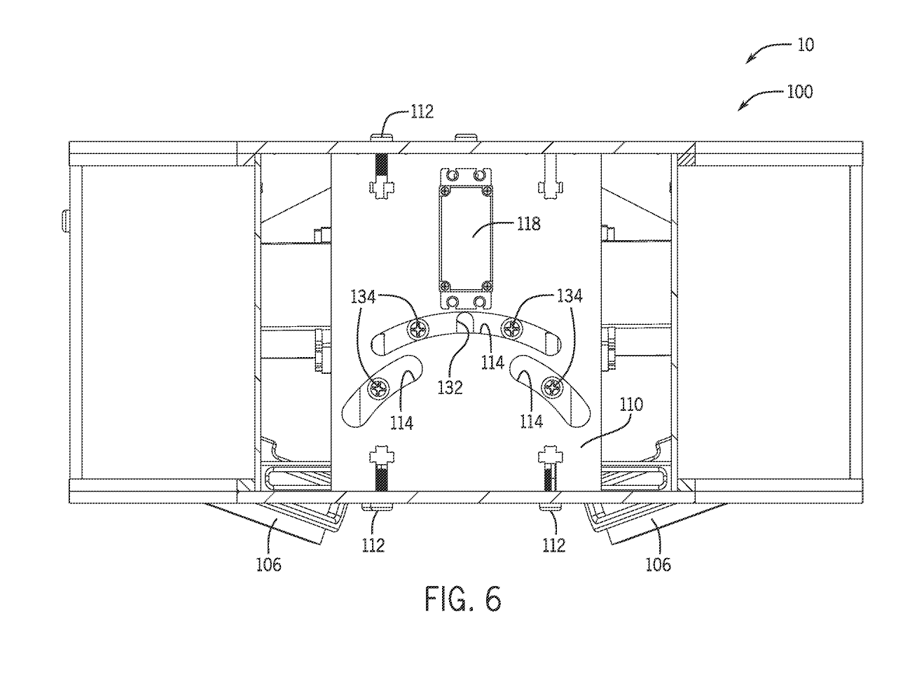

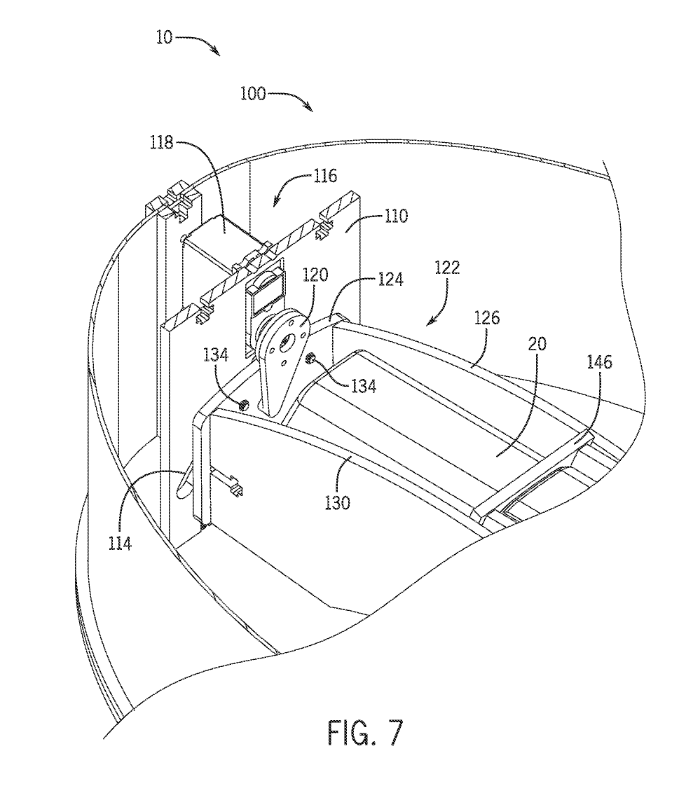

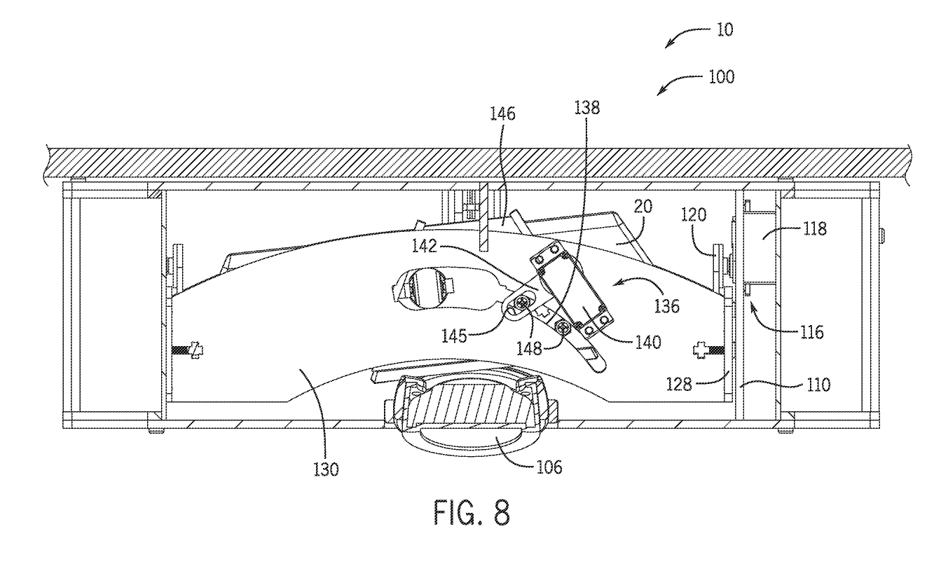

With reference to FIGS. 5-8, a pair of opposed mounting plates 110 are arranged within the housing 100 and both mounted to the housing 100 with a plurality of plate fastening elements 112. Each of the pair of mounting plates 110 includes a plurality of mounting plate curvilinear tracks 114 and a first electromechanical assembly 116. The first electromechanical assembly 116 includes a first electromechanical feature 118 in the form of a servomotor attached to the mounting plate 110 and first crank element 120 coupled to the electromechanical feature 118. In the illustrated, non-limiting example, there are three mounting plate curvilinear tracks 114, as shown in FIG. 6, however, the quantity and arrangement of the mounting plate curvilinear tracks 114 may be different in other non-limiting configurations.

The pair of opposed mounting plates 118 are spaced apart such that a pivot frame 122 can be arranged therebetween. The pivot frame 122 includes a first pivot frame side 124, a second pivot frame side 126, a third pivot frame side 128, and a fourth pivot frame side 130. The first pivot frame side 124 and the third pivot frame side 128 each include a first crank slot 132 engaging the first crank element 120 and a plurality of coupling elements 134. At least one of the plurality of coupling elements 134 are received by each of the plurality of mounting plate curvilinear tracks 114 in the mounting plate 110.

The second pivot frame side 126 and the fourth pivot frame side 130 each include a second electromechanical assembly 136 and a pivot frame curvilinear track 138. The second electromechanical assembly 136 includes a second electromechanical feature 140 in the form of a servo motor and a second crank element 142. The electromechanical feature 140 is attached to the pivot frame 122 using a spacer 144. The second crank element 142 includes a second crank slot 145.

The second pivot frame side 126 and the fourth pivot frame side 130 are each coupled to a camera mounting frame 146 by a plurality of pivot frame fastener elements 148. The pivot frame fastener elements 148 are configured to fasten the pivot frame 122 to the camera mounting frame 146, and arranged such that the plurality of pivot frame fastener elements 148 are received by the pivot frame curvilinear track 138 and at least one of the plurality of fastener elements 148 is also received by the second crank slot 145 of the second crank element 142. The camera mounting frame 146 includes a first camera aperture 150 and a second camera aperture 152 both dimensioned to receive the camera 20, as shown in FIG. 5.

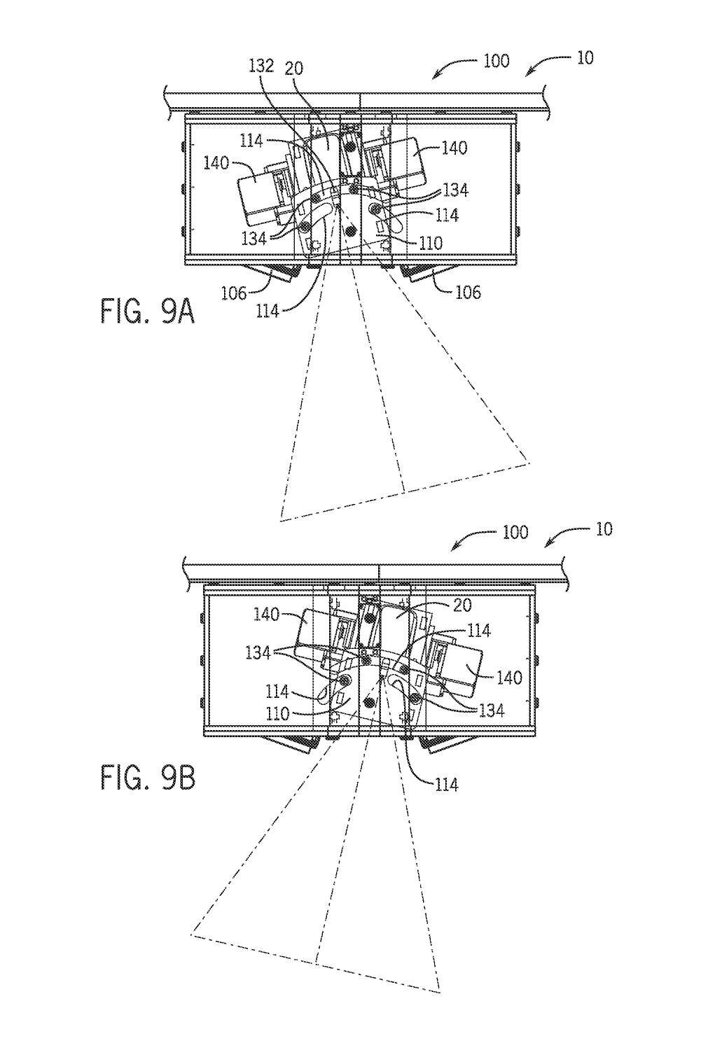

In operation, the first electromechanical feature 118 drives the first crank element 120 to rotate in either a clockwise or a counterclockwise direction. Since the first crank element 120 is in engagement with the first crank slot 132, rotation of the first crank element 120 causes displacement of the plurality of coupling elements 134 along the plurality of mounting plate curvilinear tracks 114 thereby rotating the pivot frame 122 and the camera 20 in a plane relative to a latitudinal direction of the bed 14, as shown in FIGS. 9A and 9B.

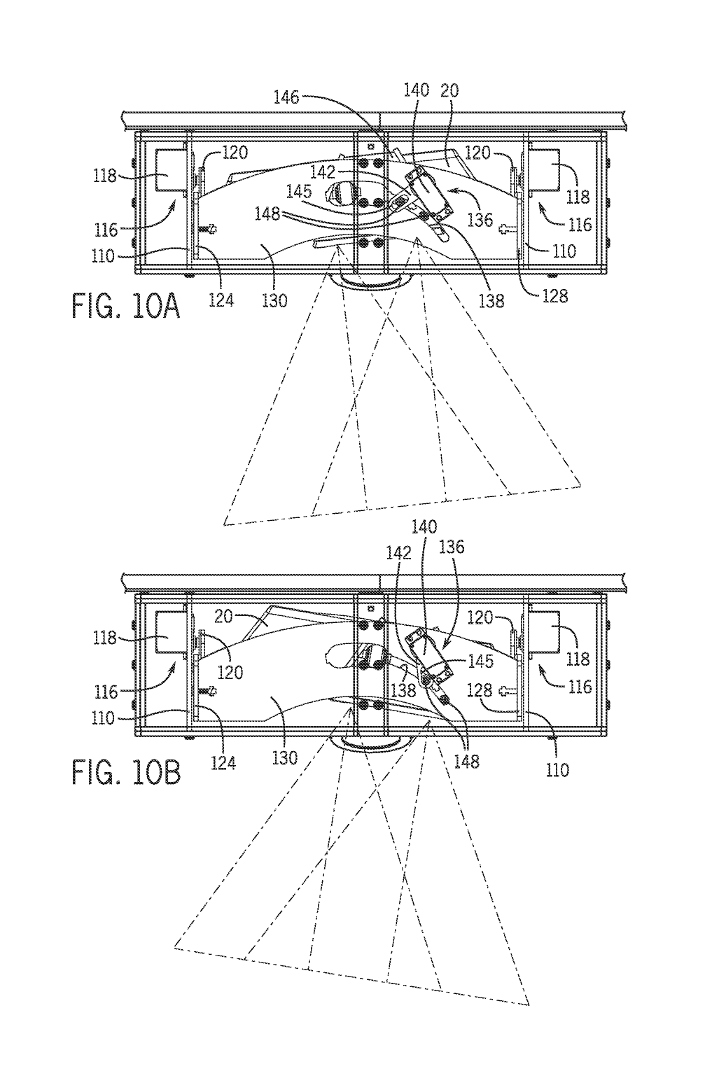

The second electromechanical feature 140 drives the second crank element 142 to rotate in either a clockwise or a counterclockwise direction. Since the plurality of pivot frame fastener elements 148 are received by the pivot frame curvilinear track 138 and at least one of the plurality of pivot frame fastener elements 148 is received by the second crank slot 145, rotation of the second crank element 142 causes displacement of the plurality of pivot frame fastener elements 148 along the pivot frame curvilinear track 138 thereby rotating the pivot frame 122 and the camera 20 in a plane relative to a longitudinal direction of the bed 14, as shown in FIGS. 10A and 10B.

In the illustrated non-limiting example described above, each of the mounting plates 110 includes a first electromechanical assembly 116 and each of the second pivot frame side 126 and the fourth pivot frame side 130 include a second electromechanical assembly 136. This arrangement reduces the load requirement for each of the electromechanical assemblies 116, 136. However, the same rotational function could be provided using only one first electromechanical assembly 116 and one second electromechanical assembly 136, in other non-limiting configurations. In still other non-limiting configurations, the housing 100 may include additional electromechanical features controlling the positioning of the lighting features 106 and/or providing a third degree of rotation for the camera 20. In further still non-limiting configurations, the electromechanical features 118,140 may take the form of any viable electromechanical device known in the art that can be configured to provide rotation of the crank elements 120,142.

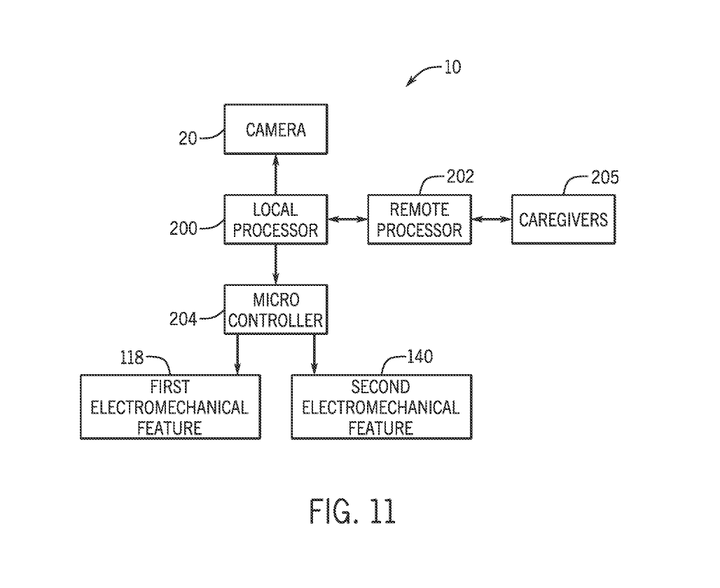

A non-limiting example of the operation of the medical monitoring system 10 will be described with reference to FIGS. 11-16. As shown in FIG. 11, the medical monitoring system 10 may include a local processor 200 in communication with the camera 20. The camera 20 may be in direct wired communication with the local processor 200, for example, via a universal serial bus (USB) connection, or the camera 20 may be in wireless communication with the local processor 200 using any wireless communication method known in the art or developed in the future.

The local processor 200 is also in communication with a remote processor 202 and a microcontroller 204. The remote processor 202 can be a repository server located at a facility where the patient 12 is located and may include personal and/or medical information of the patient 12. The remote processor 202 can be in direct wired communication with the local processor 200, for example, via a Ethernet cable, or the remote processor 202 can be in wireless communication with the local processor 200, for example, via a dedicated Wi-Fi (802.11) link or any wireless communication method known in the art or developed in the future. The remote processor 202 may be connected via the Internet and data communicated to the remote processor 202 or created by the remote processor 202 may be stored remotely online. The remote processor 202 is in communication with one or more caregivers 205 (either home or professional caregivers). The remote processor 202 can be in direct wired communication with the caregivers 205, or the remote processor 202 can be in wireless communication with caregivers 205, for example, via a dedicated Wi-Fi (802.11) link or any wireless communication method known in the art or developed in the future.

The microcontroller 204 is in communication with the first electromechanical features 118 and the second electromechanical features 140. This enables either the local processor 200 or the remote processor 202 to control the rotation of the first electromechanical features 118 and the second electromechanical features 140. The microcontroller 204 could also control additional electromechanical features controlling the lighting feature positioning and/or third degree of rotation of the camera 20.

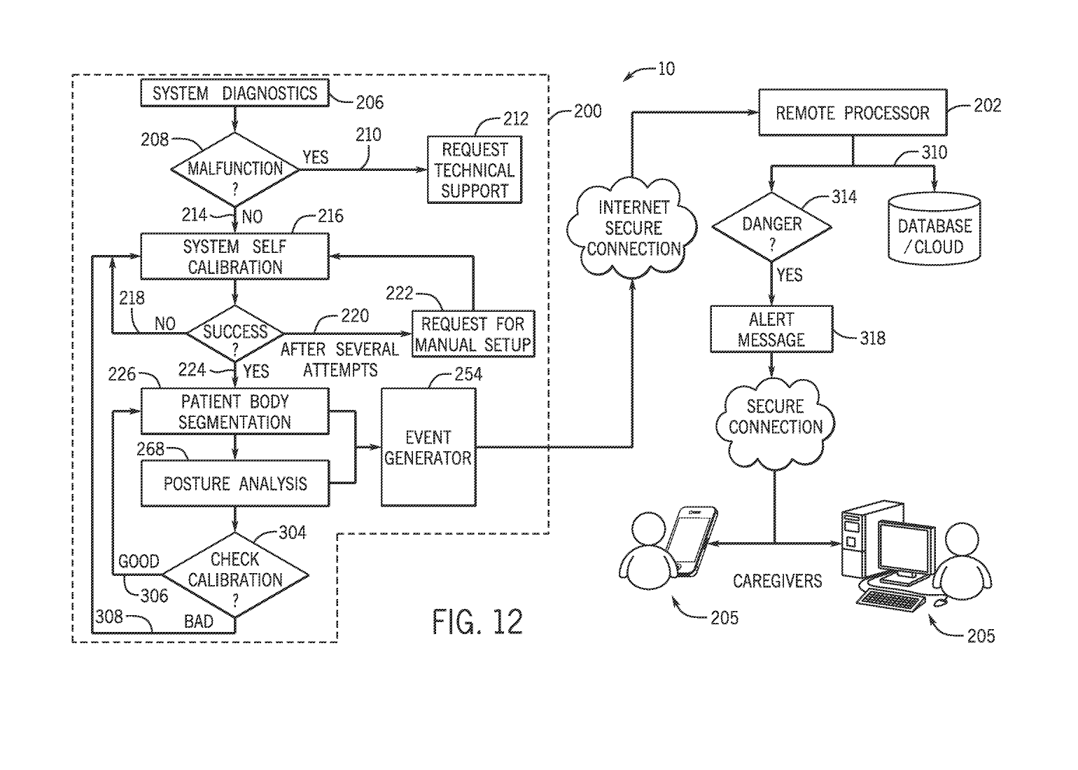

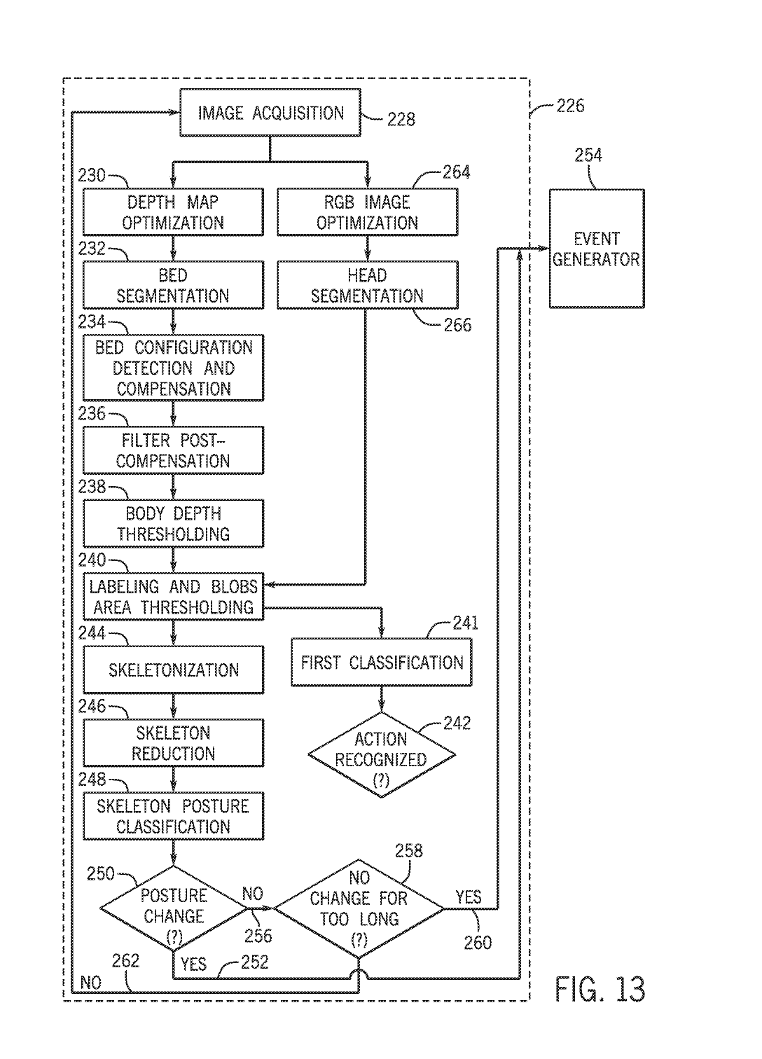

As described above, the camera 20 is configured to acquire images of the patient 12 in or around the bed 14. The local processor 200 is configured to processes the images and determine a positional state, or a sequence of positional states, of the patient 14 on or around the bed 12. The steps for determining the positional state of the patient 14 on or around the bed 12 will be described with reference to FIGS. 12 and 13. As shown in FIG. 12, the local processor 200 begins by performing system diagnostics 206 where the local processor 200 determines 208 if that the camera 20, the lighting features 30,106, the microcontroller 204, the first electromechanical features 118 and the second electromechanical features 140 are operating properly. If a malfunction is detected 210, a request for technical support 212 is sent from the local processor 200 to the caregivers 205 via the remote processor 202. If no malfunction is detected 214, a self-calibration process 216 is performed where the camera 20 begins to acquire images of the patient 12 in or around the bed 14. During the self-calibration process 216, environmental conditions, such as lighting and objects near the bed, are calibrated for in the images. Additionally, the local processor 200 verifies that the camera 20 is producing images including the entire bed by constructing threshold planes around the edges of the bed 14. Furthermore, the local processor 200 is configured to instruct the microcontroller 204 to rotate the camera 20 to enable the camera 20 to view the entire bed 14.

If the self-calibration process 216 fails 218, the self-calibration 216 starts over and the local processor 200 may rotate the camera 20 via the microcontroller 204. If the self-calibration process 216 fails a predetermined numbers of times 220, the local processor sends a request for manual calibration 222 to the caregivers 205 via the remote processor 202. Once a successful self-calibration process 206 is detected 224, a patient body segmentation process 226 is enabled.

It should be known that the following description of the patient body segmentation process 226 is one exemplary non-limiting example and, as will be recognized by one of ordinary skill in the art, different steps may be used. Furthermore, in one non-limiting configuration, one or more patient body segmentation processes 226 may be executed in parallel and selectively switched between based on accuracy.

The steps of the patient body segmentation process 226 will be described with reference to FIG. 13. The patient body segmentation process 226 begins with the camera acquiring an image 228 of the patient 12 in or around the bed 14. The image contains 3-D depth data that may be optimized 230 by reducing the noise in the image, for example, using a low-pass filter, and interpolating for any holes present in the image. Once the 3-D depth data in the image is optimized 230, the bed 14 in the image is segmented 232 using, for example, floor distance thresholding to remove all data in the image from the bed 14 to the floor and shape filtering to extract a silhouette of the patient 14 in or around the bed 12. Following the segmentation 232 of the 3-D depth map in the image, a detection/compensation 234 step is capable of detecting whether any portion of the bed 14 is in a reclined state and compensating for the depth change caused by the reclined state of the bed 14. Thereafter, the image passes through a post-compensation filter 236. The detection/compensation 234 and post-compensation filter 236 steps would have no effect on the image data if the bed 14 is in a flat state, or the surface the patient 12 is upon is parallel with the floor the bed 14 is on.

The remaining data in the image is then passed through a labeling/area thresholding 240 step where 3-D objects in the image are labeled and area thresholding is used to remove all of the 3-D objects from the image smaller than a specific size and/or the 3-D objects that can be attributed to noise or an unpredictable configuration of a blanket/sheet on the patient 12 or pillows or other materials in the bed. Upon labeling/area thresholding 240 of the image, the remaining data can be used to provide a first classification 241 of a positional state of the patient 12 in or around the bed 14 can be determined 242. However, the patient 12 can often be covered by a blanket/sheet or located closely to pillows or other materials in the bed, which may cause the first classification 241 to be unsuccessful. Thus, the image is passed through a skeletonization filter 244 that is used to provide a non-anatomical skeleton-like structure in the image. In the illustrated, non-limiting example, the skeletonization filter 244 may connect local maximums from the 3-D depth data in the image to provide the non-anatomical skeleton-like structure and use branch filters to remove minor artifacts affecting the non-anatomical skeleton-like structure. Alternatively, in other non-limiting examples, the skeletonization filter 244 may use any segmentation and recognition methods known in the art or developed in the future.

The non-anatomical skeleton-like structure in the image is then reduced 246 to identify, for example, at least a head, legs, and a torso in the non-anatomical skeleton-like structure to be used for positional state classification 248. The positional state classification 248 can use a positional state recognition algorithm that associates the shape of the reduced 246 non-anatomical skeleton-like structure with a positional state of the patient 12. The positional state of the patient 12 may be any information relating to how the patient 12 is positioned in or around the bed 14. For example, the patient 12 is lying in the middle of the bed 14, the patient 12 is sitting on the side of the bed 14, or the patient is standing next to the right/left side of the bed 14, to name a few.

Following the positional state classification 248, whether the current positional state is different than a previous positional state of the patient 12 is determined 250. If so 252, the current positional state is communicated to an event generator 254 and another image is acquired 228 by the camera 20 and the patient body segmentation process 226 begins again. If the current positional state of the patient 12 is not 256 different than a previous positional state of the patient 12, it is determined 258 if the patient 12 has not changed their positional state for a predetermined period of time that is deemed to be too long. Upon determining that the patient 12 has 260 exceeded the predetermined period of time for not changing their positional state, a message stating this is communicated to the event generator 254. If the patient has not 262 exceeded the predetermined period of time, another image is acquired 228 by the camera 20 and the patient body segmentation process 226 begins again.

In one non-limiting example, the camera 20 may acquire RGB image data along with the 3-D depth map data. In this non-limiting example, the patient segmentation process 226 includes steps 264, 266 for optimizing the RGB image data and segmenting a head of the patient 12. This information can then be used during the labeling/area thresholding 240 step for the 3-D depth map data.

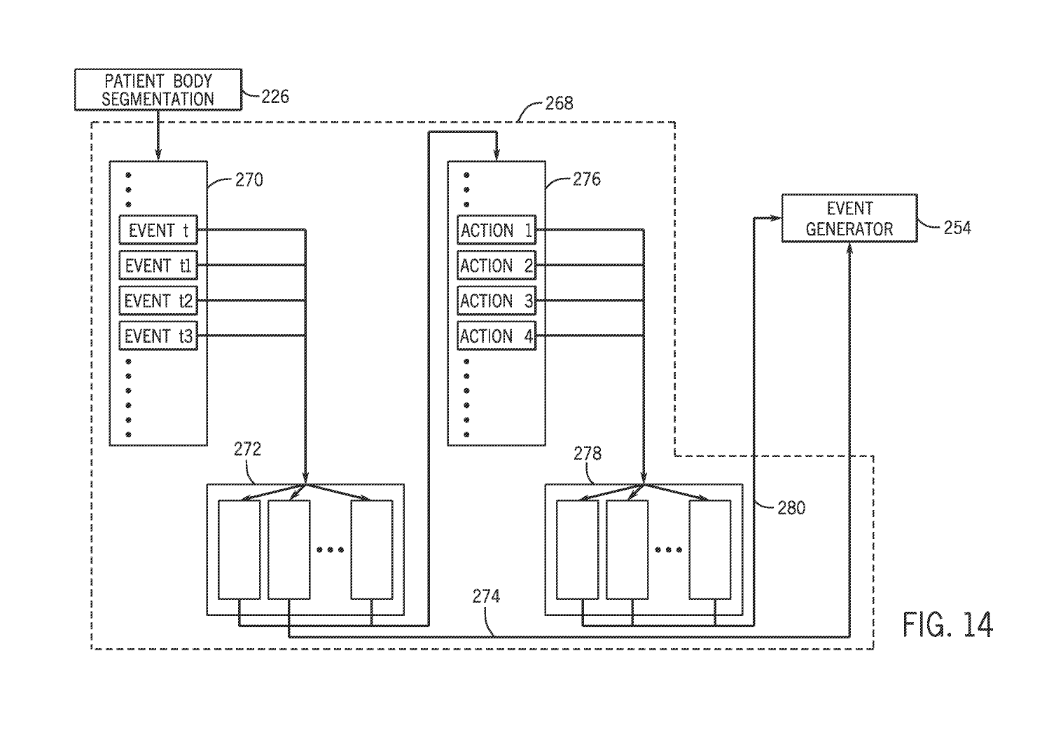

With reference back to FIG. 12, the patient body segmentation process 226 continually loops, as previously described, and one or more positional states of the patient 12 are then analyzed 268. One non-limiting example of the steps for the positional state analysis 268 will be described with reference to FIG. 14. As shown in FIG. 14, the output from the patient body segmentation 226 is communicated to the positional state analysis 268 in a sequence of positional states 270. Each positional state in the sequence of positional states 270 include a time at which the positional state occurred. The sequence of positional states 270 are then passed to a one or more pattern recognition algorithms 272 operating independently and in parallel. The one or more pattern recognition algorithms 272 may include one or more state machines and one or more neural networks. In other non-limiting examples, the one or more pattern recognition algorithms 272 may include any statistical models/algorithms capable of pattern recognition known in the art or developed in the future.

The one or more pattern recognition algorithms 272 each analyze the sequence of positional states 270 and can identify an action based on a specific combination or order of positional states. For example, the sequence of positional states 270 may include the patient 12 lying in the middle of the bed 14 at time t0, the patient 12 sitting on the left side of the bed 14 at time t1, and the patient 12 standing next to the left side of the bed 14 at time t2. In this non-limiting example, the one or more pattern recognition algorithms 272 may recognize this sequence of positional states 270 as an action of the patient getting out of the bed 14. Additionally, the one or more pattern recognitions algorithms 272 may identify a particular positional state and communicate 274 the particular positional state to the event generator 254.

A sequence of actions 276 are output from the one or more pattern recognition algorithms 272 which are then passed through one or more action recognition algorithms 278 operating independently and in parallel. The one or more action recognition algorithms 278 may include one or more state machines and one or more neural networks. In other non-limiting examples, the one or more action recognition algorithms 278 may include any statistical model/algorithm capable of pattern recognition known in the art or developed in the future. The one or more action recognition algorithms 278 each analyze the sequence of actions 276 and can identify a particular action, or a particular combination of actions, and communicate 280 the particular action, of the particular combination of actions to the event generator 254.

Although the operation of the positional state analysis 268 was described where the sequence of positional states 270 can be identified into the sequence of actions 276, it would known by one of ordinary skill in the art that the positional state analysis 268 may include additional identification steps. For example, the one or more action recognition algorithms 278 could identify a process, such as, the patient 12 walking around the bed 14, from the sequence of actions 276, and so on.

As stated above, the one or more pattern recognition algorithms 272 may include a state machine and a neural network. The operation of these two non-limiting examples will be described with reference to identifying an action from a sequence of positional states. However, a similar description would apply to the one or more action recognition algorithms 278 when identifying a particular sequence of actions.

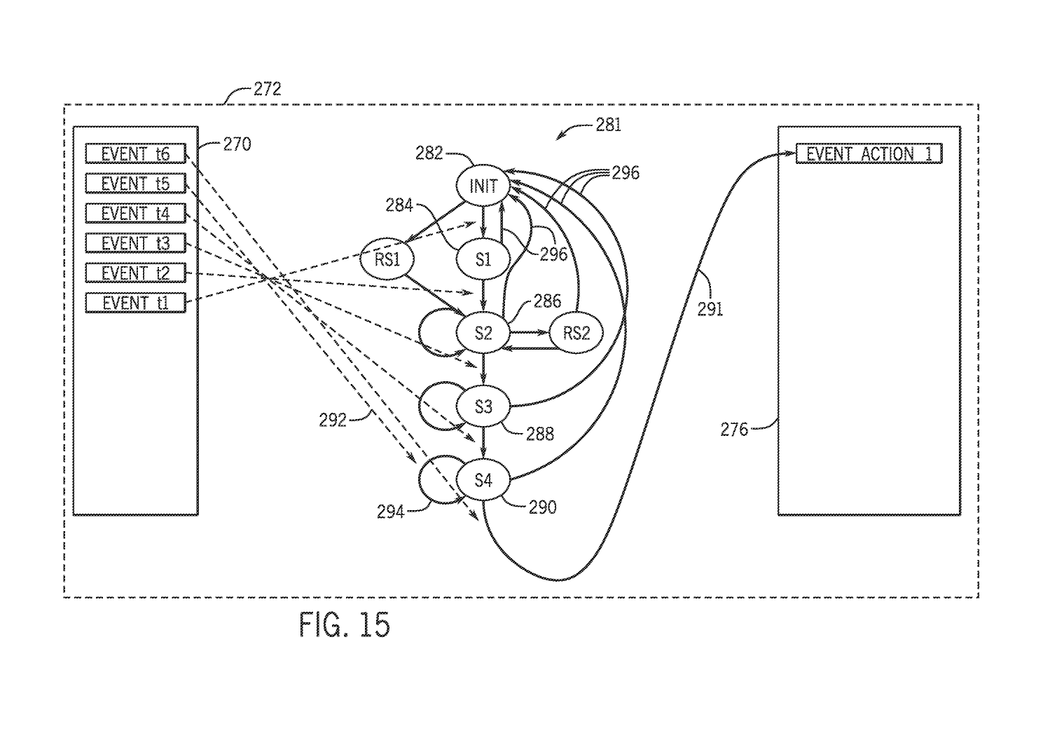

FIG. 15 shows a non-limiting example of a state machine 281 operating as one of the one or more pattern recognition algorithms 272. The state machine 281 includes an initialized state 282, a first state 284, a second state 286, a third state 288, and a fourth state 290. As the sequence of positional states 270 are input into the state machine 281, the state machine 281 can be configured to advance from the first state 282 to the fourth state 290 when the sequence of positional states 270 includes one or more positional states that can be identified 291 as an action. The state machine 281 can be configured to recognize a positional state that does not merit advancing the state machine 281, and remain in its current state. For example, a positional state at time t5 is input 292 to the state machine 281 while in the fourth state 290. The state machine 281 recognizes that the positional state at time t5 does not merit advancing the state machine 281 so it remains 294 in the fourth state 290. Furthermore, the state machine 281 can be configured to recognize a positional state that is not probable based on the previous state, and reset 296 the state machine 281 from its current state to the initialized state 282. For example, the patient 12 is lying in the center of the bed at time t1 advances the state monitor from the initialized state 282 to the first state 284 and then the state machine 281 receives the patient 12 is standing on the left side of the bed 14. This non-limiting sequence of positional states would cause the state machine 281 to reset 296 to its initialized state 282.

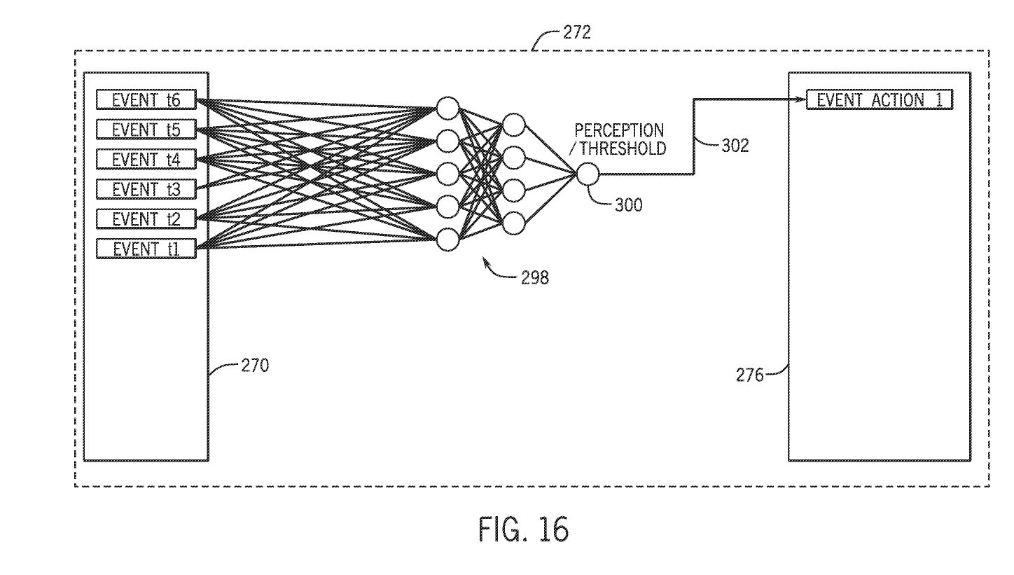

FIG. 16 shows a non-limiting example of a neural network 298 operating as one of the one or more pattern recognition algorithms 272. The operation of a neural network is well known in the art; therefore, the description will begin at a perception/threshold 300 step where the neural network has already identified a possible action based on any combination of positional states in the sequence of positional states 270. The perception/threshold 300 step includes one or more parameters that can be tuned to trigger the generation 302 of an action. The parameters in the perception/threshold step can be modified over time and the neural network 298 can be configured to adaptively learn over time. This could enable the neural network 298 to identify new actions, or positional states, over time and these new actions, or new positional states, could be communicated to the other pattern recognitions algorithms 272.

With reference back to FIG. 12, following the positional state analysis 268, the current calibration is checked 304. If the current calibration is valid 306, the patient body segmentation process 226 is allowed to resume. If the current calibration is not valid 308, the self-calibration process 216 will be carried out.

As was previously described, the event generator 254 receives communications from the patient body segmentation process 226 in the form of a positional state and a time and from the positional state analysis 268 in the form of a positional state, or an action, and a time. These communications are sent to the remote processor 202 via the local processor 200. Once received by the remote processor 202, the communications sent from the event generator 254 are sent 310 to a storage device 312. The storage device 312 may be a server in communication with the remote processor 202 or a cloud-type storage system in communication with the remote processor 202 or a hard drive or similar device built into the remote processor 202. Additionally, the remote processor 202 is configured to determine 314 if the patient 12 is in a dangerous positional state, and/or has completed a dangerous sequence of positional states, based on the communications received from the event generator 254. If the remoter processor 202 determines 314 the patient 12 is in danger 316, then an alert message 318 is communicated to the caregivers 205. As described above, the remote processor 202 can communicate with the caregivers 205, in which case the alert message 318 could be communicated to an on-site computer or command center at the caregivers' facility. Alternatively, the remote processor 202 may be in wireless communication with the caregivers 205 in which case the alert message 318 could be communicated to a mobile computing device. Additionally or alternatively, other alerts or efforts to assist may be communicated. For example, upon determining that an alert message 318 is to be generated, lights within the room or otherwise associated with the medical monitoring system 10, whether integrated or separate from the medical monitoring system 10, may be illuminated. Additionally or alternatively, a pre-recorded message may be played for the patient 12 to encourage the patient 12 to move from the position or action that caused the alert message 318. For example, the alert message 318 may tell the patient 12 to move away from the edge of the bed 14 or the like. Also, the patient 12 may be enabled to engage the alert message 318 generation process, for example, by way of a voice request or actuation of a user interface to alert the caregivers 205.

Dangerous position states or sequences of positional states may include, as non-limiting examples, being located too close to the edge of the bed 14, hanging from the edge of the bed 14, sitting up, failure to move for a predetermined period of time, moving rapidly from one position to another, laying on the floor, and the like. Thus, the above-described system 10 may be configured to identify an act in response to any of a variety of conditions. Furthermore, as will be described, the system 10 may be configured to learn or adapt to other or new conditions. Further still, alerts 318 may be generated in escalating levels of urgency or type as a dangerous position continues through a sequence of positional states or increases in individual severity. As a non-limiting example, alert types may change as a patient hangs from the bed 14, stands up, and ultimately leaves the view of the system 10. In this non-limiting example, being located in a position close to the edge of the bed 14 may be determined to be a dangerous state. However, successfully standing may be determined to be a less dangerous state for a particular patient 12 (of course, for other patients, standing may be highly dangerous). Furthermore, leaving the view of the system may be cause for an alert 318 that the patient 318 is wandering and no longer in range of the system 10.

Exemplary advantages of the above-described medical monitoring system 10 or other medical monitoring systems designed or created using the above-described techniques or properties, will be discussed below with reference to FIGS. 1-16. For example, the above-described information may be reported and/or this and additional information aggregated by the above-described or other parties to make further determinations and clinical assessments. For example, particular movements may be tracked and included in or compiled to create a clinical assessment of the subject. Such information may be used to determine a prognosis, medical assessment, pharmaceutical assessment, sleep studies, or the like. That is, the systems and methods described herein may serve as in input to an individual or aggregated assessment process for clinical, medical, pharmaceutical, or other studies. To assist with compiling desired information or reporting to the caregiver, video may be recorded. When there is no movement or the system has identified a lack of movement considered to be within normal parameters (such as during sleeping or resting quietly), video recording or saving may be reduced to save data storage. Additionally or alternatively, after a predetermined amount of data is captured for a given statistical purpose, such as a pharmaceutical study, recorded video or data may be limited or even purged. Additionally or alternatively, video recording may be controlled or limited by the subject or may only occur with subject permission, to maintain privacy. By no means is the following an exhaustive list of the numerous advantages provided by the invention, as will be understood by one of skill in the art.

The medical monitoring system 10 is configured to identify a positional state of a patient 12 in or around the bed 14 and is further configured to identify unknown sequences of predetermined positional states. In some cases, an unknown sequence may be used as a trigger to send an alert or seek feedback from a user or caregiver to characterize the unknown sequence. Furthermore, the medical monitoring system 10 is configured to send an alert message 318 to one or more caregivers 205 if the patient 12 is in a dangerous positional state, or has completed a dangerous sequence of positional states. To this end, the system 10 may self-reset once the dangerous positional state is not longer detected or a safe state is detected. Also, alerts may cease once another person, such as a caregiver (home or professional) or clinician is detected by the system 10. Facial or body recognition or RF ID or other recognition system may be integrated into the system and use to determine the presence of such a person. This allows the facility employing the caregivers 205 to staff fewer caregivers for a given number of patients.

Additionally, the medical monitoring system 10 is able to identify a positional state of the patient 12 even if the patient 12 is covered by a blanket/sheet due to the skeletonization filter 244 generating a non-anatomical skeleton structure.

Furthermore, the medical monitoring system 10 is configured to send the communications from the event generator 254 to a storage device 312, which may be used to develop a quantitative database of known positional states. This quantitative database could be used to conduct clinical studies to aid a physician in determining if a medical condition of the patient 12 is getting better or worsening based on the data from the medical monitoring system 10. Generation of the quantitative database could be accelerated by installing a plurality of medical monitoring systems in a plurality of facilities employing caregivers monitoring patients where each of the plurality of medical monitoring systems is in communication with the storage device 312 via the remote processor 202.

It is to be understood that the invention is not limited in its application to the details of construction and the arrangement of components set forth in the following description or illustrated in the following drawings. The invention is capable of other configurations and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The above discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The preceding detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Thus, while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

We claim:

1. A medical monitoring system comprising:
a housing configured to be mounted proximate to a bed;
a camera rotatably mounted within the housing and arranged to acquire images of a patient in or around the bed; and
a processor configured to process the images acquired by the camera and determine a positional state of the patient.

2. The medical monitoring system of claim 1 further comprising one or more first electromechanical assemblies configured to rotate the camera relative to a latitudinal direction of the bed and one or more second electromechanical assemblies configured to rotate the camera relative to a longitudinal direction of the bed.

3. The medical monitoring system of claim 1, wherein the processor is further configured to perform a self-calibration process calibrating the images acquired by the camera.

4. The medical monitoring system of claim 1, wherein the processor is further configured to generate a model of a non-anatomical skeleton structure of the patient in the images.

5. The medical monitoring system of claim 4, wherein the processor determines the positional state of the patient based on a shape of the non-anatomical skeleton structure of the patient in the images.

6. The medical monitoring system of claim 5 further comprising a remote processor in communication with the processor and configured to determine if the patient is a dangerous positional state.

7. The medical monitoring system of claim 6, wherein the remote processor is in communication with one or more caregivers and is further configured to communicate an alert message to the one or more caregivers upon determining that the patient is in a dangerous positional state.

8. The medical monitoring system of claim 4, wherein the processor is configured to use the non-anatomical skeleton structure to determine the positional state of the patient when the patient is covered by a blanket or a sheet.

9. A medical monitoring system comprising:
a housing configured to be mounted above a bed;
a camera rotatably mounted within the housing and arranged to acquire images of a patient on or around the bed;
a local processor configured to process the images acquired by the camera and determine a positional state, or a sequence of positional states, of the patient, wherein the local processor is further configured to generate event data including the positional state, or the sequence of positional states, and a time; and
a remote processor located remotely from the local processor and in communication with the local processor, wherein the remote processor is configured to receive the event data from the local processor and determine when the patient is in danger and communicate to one or more caregivers an alert message.

10. The medical monitoring system of claim 9, wherein one of the local processor and the remote processor is further configured to identify an improbable positional state within the sequence of positional states and not include the improbable positional state in the event data or not communicate the alert message.

11. The medical monitoring system of claim 9, wherein the local processor is further configured to adaptively learn new positional states, or new probable sequences of positional states.

12. The medical monitoring system of claim 9, wherein the local processor is further configured to identify a specific order or combination of positional states within the sequence of positional states as an action.

13. The medical monitoring system of claim 12, wherein the local processor is further configured to use one or more state machines or one or more neural networks operating independently and in parallel to identify the specific order or combination of positional states within the sequence of positional states as the action.

13. The medical monitoring system of claim 9, wherein the local processor is further configured to generate a non-anatomical skeleton structure of the patient in the images.

14. The medical monitoring system of claim 13, wherein the local processor determines the positional state, or the sequence of positional states, of the patient based on a shape of the non-anatomical skeleton structure of the patient in the images.

15. The medical monitoring system of claim 9, wherein the remote processor is in communication with a storage device.

16. The medical monitoring system of claim 15, wherein the remote processor is further configured to send the event data received from the local processor to the storage device.

17. A method for remotely monitoring a patient in or around a bed, the method comprising:
imaging the patient in or around the bed with a camera mounted above the bed, the camera being rotatably mounted within a housing;
determining a positional state of the patient in the bed;
communicating the positional state of the patient and a time to a remote processor;
generating an alert message upon determining, with the remote processor, that the patient is in danger; and
notifying one or more caregivers of the alert message.

18. The method of claim 17 further comprising determining a specific order or combination of positional states qualify as an action.

19. The method of claim 17, wherein the positional state of the patient is determined by a shape of a non-anatomical skeleton structure of the patient.

20. The method of claim 17 further comprising storing the positional state of the patient and the time on a storage device.
